(19) United States
(12) Patent Application Publication
(10) Pub. No.: US 2025/0392990 A1
(43) Pub. Date: Dec. 25, 2025

(54) METHODS, DEVICES, AND MEDIUM FOR COMMUNICATION

(71) Applicant: NEC Corporation, Tokyo (JP)

(72) Inventors: Lei CHEN, Beijing (CN); Gang WANG, Beijing (CN)

(73) Assignee: NEC Corporation, Tokyo (JP)

(21) Appl. No.: 18/879,406

(22) PCT Filed: Jul. 1, 2022
(86) PCT No.: PCT/CN2022/103481

§ 371 Date: Dec. 27, 2024

(51) Int. Cl. H04W 52/02; H04W 74/0833; H04W 76/28

(52) U.S. Cl. CPC H04W 52/0235; H04W 74/0833; H04W 76/28

(57) ABSTRACT

Example embodiments of the present disclosure relate to methods, devices, and computer storage medium for communication. A terminal device selects a target transmission and reception (TX/RX) mode from a plurality of TX/RX modes of a serving cell of a network device based on a predefined condition associated with the target TX/RX mode. The terminal device transmits, to the network device, wake-up information requesting the serving cell in a discontinuous transmission or reception (DTX/DRX) mode to wake up into the target TX/RX mode. As such, with the wake-up information, a serving cell may be requested to wake up into a target TX/RX mode of the plurality of TX/RX modes. In other words, a joint design of the cell wake-up and the on-demand common signal may be achieved.

### FIELD

Example embodiments of the present disclosure generally relate to the field of communication techniques and in particular, to methods, devices, and a computer readable medium for communication.

### BACKGROUND

Discontinuous transmission has been widely used in communication systems for energy saving. For example, a user equipment (UE) and/or a gNodeB in a discontinuous transmission or reception (DRX/DTX) mode may temporarily stop its transmission or reception in off-durations for energy saving.

For a serving cell in the DTX/DRX mode, the gNodeB will discontinuously transmit downlink (DL) channels/signals and discontinuously receives uplink (UL) signals. However, for some critical common signal, e.g., a Synchronization Signal/Physical Broadcast CHannel block (SSB), system information block 1 (SIB1), physical random access channel (PRACH), discontinuous transmission/reception with the long off-duration may lead to severe issues of UE connection. On the other hand, if the off-duration is short, energy saving effect may be poor.

Therefore, it is a challenge to obtain a balance between the energy saving effect and UE performance.

### SUMMARY

In general, example embodiments of the present disclosure provide methods, devices and a computer storage medium for communication.

In a first aspect, there is provided a method of communication. The method comprises: selecting, at a terminal device, a target transmission and reception (TX/RX) mode from a plurality of TX/RX modes of a serving cell of a network device based on a redefined condition associated with the target TX/RX mode; and transmitting, to the network device, wake-up information requesting the serving cell in a discontinuous transmission or reception (DTX/DRX) mode to wake up into the target TX/RX mode.

In a second aspect, there is provided a method of communication. The method comprises: receiving, at a network device and from a terminal device, wake-up information requesting a serving cell, of the network device, in a discontinuous transmission or reception (DTX/DRX) mode to wake up into a target transmission and reception (TX/RX) mode of a plurality of TX/RX modes; and in response to receiving the wake-up information, configuring the serving cell in one of the DTX/DRX mode and the plurality of TX/RX modes.

In a third aspect, there is provided a terminal device. The terminal device comprises a processor and a memory. The memory is coupled to the processor and stores instructions thereon. The instructions, when executed by the processor, cause the terminal device to perform the method according to the first aspect above.

In a fourth aspect, there is provided a network device. The network device comprises a processor and a memory. The memory is coupled to the processor and stores instructions thereon. The instructions, when executed by the processor, cause the network device to perform the method according to the second aspect above.

In a fifth aspect, there is provided a computer readable medium having instructions stored thereon, the instructions, when executed on at least one processor, causing the at least one processor to carry out the method according to the first aspect or the second aspect above.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 illustrates an example communication system in which some embodiments of the present disclosure can be implemented;

FIG. 2 illustrates a signaling chart illustrating communication process in accordance with some embodiments of the present disclosure;

FIGS. 3A-3D illustrate examples of a first transmission or reception mode in accordance with some embodiments of the present disclosure;

FIGS. 4A-4C illustrate examples of a second transmission or reception mode in accordance with some embodiments of the present disclosure;

FIGS. 5A-5B illustrate examples of a third transmission or reception mode in accordance with some embodiments of the present disclosure;

FIGS. 6A-6B illustrates examples of transmission of the wake-up information in a PUCCH resource in accordance with some example embodiments of the present disclosure;

FIGS. 7A-7C illustrate examples of transmission and detection of the wake-up information in accordance with some embodiments of the present disclosure;

FIG. 8 illustrates a flowchart of an example method in accordance with some embodiments of the present disclosure;

FIG. 9 illustrates a flowchart of an example method in accordance with some embodiments of the present disclosure; and

FIG. 10 illustrates a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IOT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “terminal device” refers to any device having wireless or wired communication capabilities. Examples of terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also be incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

As used herein, the term “network device” refers to a device which is capable of providing or hosting a cell or coverage where terminal devices can communicate. Examples of a network device include, but not limited to, a satellite, a unmanned aerial systems (UAS) platform, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

Communications discussed herein may conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.85G, the third generation (3G), the fourth generation (4G), 4.5G, the fifth generation (5G), and the sixth (6G) communication protocols. The techniques described herein may be used for the wireless networks and radio technologies mentioned above as well as other wireless networks and radio technologies. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The terminal device or the network device may have Artificial intelligence (AI) or machine learning capability. It generally includes a model which has been trained from numerous collected data for a specific function, and can be used to predict some information.

The terminal device or the network device may work on several frequency ranges, e.g. FR1 (410 MHZ-7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network device under Multi-Radio Dual Connectivity (MR-DC) application scenario. The terminal device or the network device can work on full duplex, flexible duplex and cross division duplex modes.

The embodiments of the present disclosure may be performed in test equipment, e.g., signal generator, signal analyzer, spectrum analyzer, network analyzer, test terminal device, test network device, or channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As stated above, it is a challenge to obtain a balance between the energy saving effect and UE performance.

In previous releases, a UE wake-up signal has been specified to indicate that whether a UE will wake up from the DRX mode. For example, the UE may be indicated to start an on-duration in a next DRX cycle if receiving the UE wake-up signal which indicates the UE to wake up and keep sleeping in the next DRX cycle if receiving the UE wake-up signal which indicates UE to not wake up.

It is proposed that a cell wake-up signal may be utilized likewise to request a cell to wake up from the DTX/DRX mode. For example, the gNodeB, in an active state, may detect the cell wake-up signal in a predefined occasion of the cell wake-up signal. If the cell wake-up signal is detected, the gNodeB may reside in the active state to serve UEs in a connected mode. Otherwise, If the cell wake-up signal is not detected in the occasion, the gNodeB would go back to a sleep state in which it does not monitor pre-configured resources (e.g., RO, small data transmission) and may not transmit cell-specific broadcast signals (e.g., SSB and SIB1). As a result, the gNodeB can reside in a deeper sleep for energy saving.

However, with the cell wake-up signal in this solution, the gNodeB may be only requested to wake up or not. Moreover, for the gNodeB waking up in the active state, some common signals (e.g., SSB, SIB1, PRACH) may be unnecessary for the UE and transmission/reception of these signals may still be a waste of energy.

Embodiments of the present disclosure provide a solution of communication. In the solution, wake-up information may be utilized to request a serving cell in the DTX/DRX mode to wake up into a target transmission or reception (TX/RX) mode of a plurality of TX/RX modes. As such, on-demand signaling in the woken serving cell may be achieved and thereby both of the energy saving effect and UE performance may be improved. Principles and implementations of the present disclosure will be described in detail below with reference to the figures.

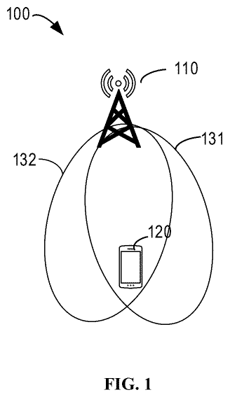

FIG. 1 illustrates an example communication system 100 in which some embodiments of the present disclosure can be implemented. The communication system 100, which is a part of a communication network, includes a network device 110 and a terminal device 120.

The network device 110 can provide services to the terminal device 120, and the network device 110 and the terminal device 120 may communicate data and control information with each other. In some embodiments, the network device 110 and the terminal device 120 may communicate with direct links/channels.

In the system 100, a link from the network devices 110 to the terminal device 120 is referred to as a downlink (DL), while a link from the terminal device 120 to the network devices 110 is referred to as an uplink (UL). In downlink, the network device 110 is a transmitting (TX) device (or a transmitter) and the terminal device 120 is a receiving (RX) device (or a receiver). In uplink, the terminal device 120 is a transmitting TX device (or a transmitter) and the network device 110 is a RX device (or a receiver).

The network device 110 may provide one or more serving cells (also referred to as cells for short). For example, the network device 110 may provide a cell 131 and a cell 132. The cell 131 may be a primary cell (Pcell) and the cell 132 may be a secondary cell (Scell). The network device 110 may further provide a primary secondary cell (PScell).

In some embodiments, the network device 110 may provide one or more cell groups. For example, the cell 131 and the cell 132 may be in different cell groups.

The communications in the communication system 100 may conform to any suitable standards including, but not limited to, Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols.

It is to be understood that the numbers of devices and their connection relationships and types shown in FIG. 1 are only for the purpose of illustration without suggesting any limitation. The communication system 100 may include any suitable numbers of devices adapted for implementing embodiments of the present disclosure.

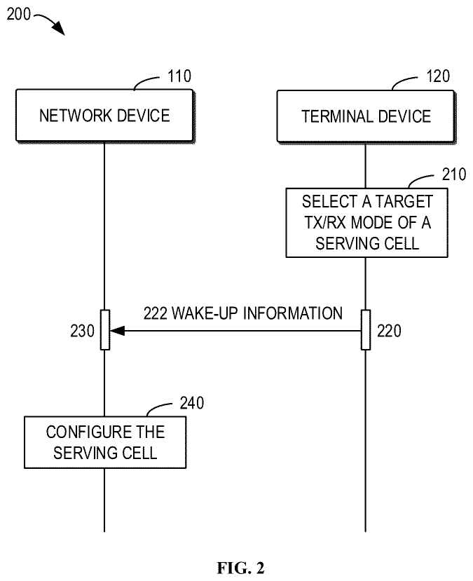

Reference is now made to FIG. 2, which illustrates a signaling chart illustrating communication process 200 in accordance with some example embodiments of the present disclosure. Only for the purpose of discussion, the process 200 will be described with reference to FIG. 1. The process 200 may involve the terminal device 120 and the network device 110.

The terminal device 120 selects 210 a target TX/RX mode from a plurality of TX/RX modes of a serving cell of the network device 110 based on a predefined condition associated with the target TX/RX mode. Each of the plurality of TX/RX modes may be associated with transmission or reception of specific signal(s) or channel(s).

In some example embodiments, the plurality of TX/RX modes may comprise at least one of the following: a first TX/RX mode in which a DL transmission is allowed, a second TX/RX mode in which a UL transmission is allowed, a third TX/RX mode in which both a DL transmission and a UL transmission are allowed, or a fourth TX/RX mode in which no transmission is allowed.

In addition, in the first TX/RX mode in which a DL transmission is allowed, no UL transmission may be allowed. In the second TX/RX mode in which a UL transmission is allowed, no DL transmission may be allowed.

As used herein, a DL/UL transmission being allowed may comprise that the DL/UL transmission is configured, transmitted or available. If a DL transmission is allowed, the terminal device 120 may monitor the DL transmission in the resources allocated for the DL transmission. Otherwise, the terminal device 120 may be not required to monitor the DL transmission. If a UL transmission is allowed, the terminal device 120 may transmit the UL transmission in the resources allocated for the UL transmission. Otherwise, the terminal device 120 may not transmit the UL transmission.

In other words, the network device 110 and the terminal device 120 may be configured with one or more TX/RX modes as discussed above depending on certain requirement or capabilities.

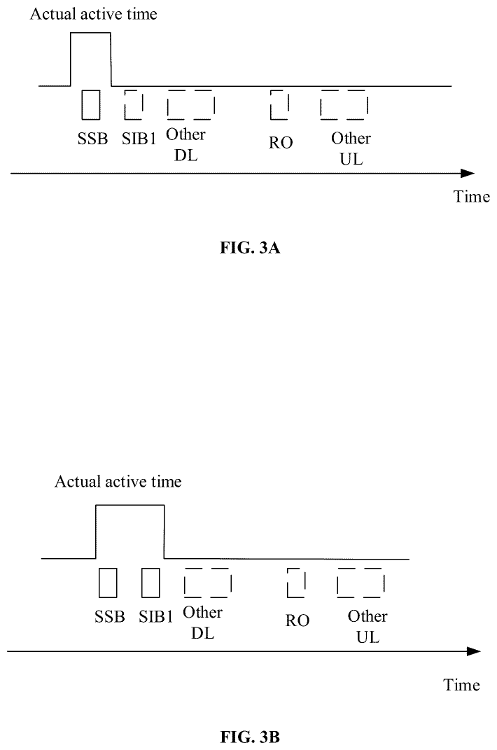

For better understanding, reference is now made to FIGS. 3A-3D, FIGS. 4A-4C, and FIGS. 5A-5B which illustrate examples of the TX/RX mode according to some embodiments of the present disclosure. FIGS. 3A-3D illustrate examples of the first TX/RX mode in accordance with some embodiments of the present disclosure.

In some example embodiments, in the first TX/RX mode in which a DL transmission is allowed, some DL transmission(s) may be allowed and some DL transmission(s) may be not allowed.

In some example embodiments, the first TX/RX mode may be a mode 1-1 in which a DL transmission for synchronization, beam management, radio resource management (RRM) measurement, or radio link monitoring is allowed.

In some example embodiments, the DL transmission for synchronization may comprise a DL transmission of a Synchronization Signal/Physical Broadcast CHannel block (SSB) or a Channel State Indication (CSI)-Reference Signal (RS). For example, a DL transmission of a CSI-RS for tracking may be allowed in the mode 1-1.

In some example embodiments, the DL transmission for beam management may comprise a DL transmission of a SSB or a CSI-RS. For example, a DL transmission of a CSI-RS for layer one (L1)-Reference Signal Received Power (RSRP) and L1-Signal to Interference and Noise Ratio (SINR) computation may be allowed.

In some example embodiments, the DL transmission for RRM measurement may comprise a DL transmission of a SSB and a CSI-RS. For example, a DL transmission of a CSI-RS for mobility may be allowed.

In some example embodiments, the DL transmission for radio link monitoring may comprise DL transmissions of SSB or CSI-RS resources configured for link monitoring.

In some example embodiments, the first TX/RX mode may be a mode 1-2 in which a DL transmission for system information is allowed. The DL transmission for system information may comprise a DL transmission of a SSB, system information block 1 (SIB1) or any other suitable system information (e.g., SIBx, where x is a positive integer other than 1).

In some example embodiments, the first TX/RX mode may be a mode 1-3 in which a DL transmission for DL data is allowed. The DL transmission for DL data may comprise a DL transmission of at least one of DL control information (e.g., PUSCH), DL traffic data (e.g., PDSCH), or a CSI-RS resource for CSI computation.

In some example embodiments, the first TX/RX mode may be a mode 1-4 in which all DL transmissions are allowed. In this mode 1-4, the DL transmission may be fully allowed.

As shown in FIG. 3A, in the mode 1-1, a DL transmission of a SSB may be allowed whereas a DL transmission of SIB1, other DL transmission (i.e., DL data transmission), a UL transmission of an random access channel (RACH) occasion (RO) and other UL transmission may be not allowed.

As shown in FIG. 3B, in the mode 1-2, both a DL transmission of the SSB and SIB1 may be allowed whereas other DL transmission, a UL transmission of an RO and other UL transmission may be not allowed.

As shown in FIG. 3C, in the mode 1-3, other DL transmission (i.e., DL data transmission) comprising a DL transmission of at least one of DL control information, DL traffic data, or a CSI-RS for CSI computation may be allowed. In contrast, a DL transmission of the SSB and SIB1 and a UL transmission of the RO and other UL transmission may be not allowed.

As shown in FIG. 3D, in the mode 1-4, all DL transmission may be allowed whereas a UL transmission of the RO and other UL transmission may be not allowed.

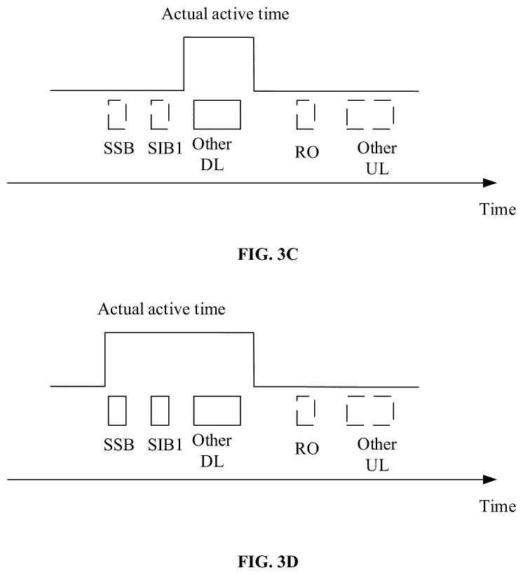

FIGS. 4A-4C illustrate examples of the second TX/RX mode in accordance with some embodiments of the present disclosure.

In some example embodiments, in the second TX/RX mode in which a UL transmission is allowed, some UL transmission(s) may be allowed and some UL transmission(s) may be not allowed.

In some example embodiments, the second TX/RX mode may be a mode 2-1 in which a UL transmission for a random access procedure is allowed. For example, a UL transmission of a physical RACH (PRACH) may be allowed in the mode 2-1. As another example, a UL transmission of message 3 may be allowed in the mode 2-1.

In some example embodiments, the second TX/RX mode may be a mode 2-2 in which a UL transmission for uplink control information or UL data is allowed. In other words, a UL transmission of a PUCCH and/or PUSCH may be allowed. For example, a small data transmission conveyed by a configured grant PUSCH may be allowed.

In some example embodiments, the second TX/RX mode may be a mode 2-3 in which all UL transmissions are allowed. In this mode 2-3, the UL transmissions of the PRACH and PUCCH/PUSCH (e.g., a configured grant PUSCH) may be fully allowed.

As shown in FIG. 4A, in the mode 2-1, a UL transmission of the RO may be allowed whereas other UL transmission and all DL transmissions may be not allowed. Alternatively, a UL transmission of the RO and other UL transmission(s) for a random access procedure may be allowed (not shown).

As shown in FIG. 4B, in the mode 2-2, other UL transmission (i.e., a UL transmission for uplink control information or UL data) may be not allowed. In contrast, a UL transmission of the RO and all DL transmissions may be not allowed.

As shown in FIG. 4C, in the mode 2-3, all UL transmissions may be allowed whereas all DL transmissions may be not allowed.

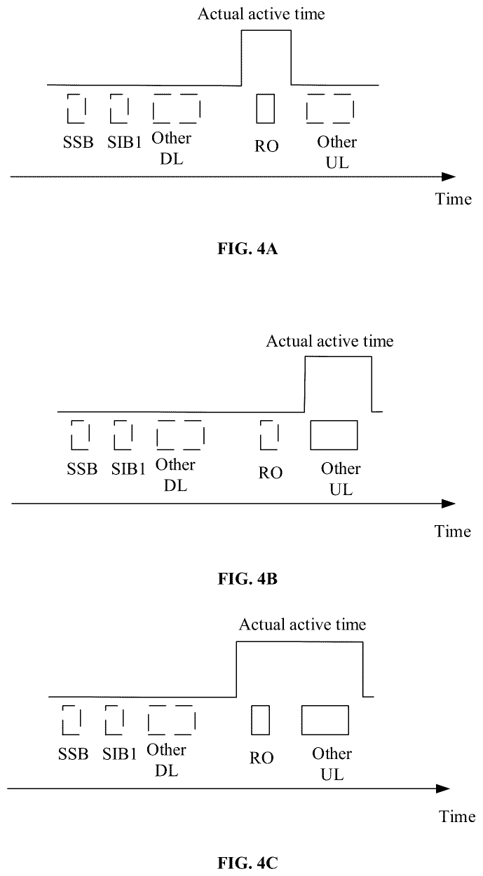

FIGS. 5A-5B illustrate examples of the third TX/RX mode in accordance with some embodiments of the present disclosure.

In some example embodiments, in the third TX/RX mode in which both a UL transmission and a DL transmission is allowed, some UL/DL transmission(s) may be allowed and some UL/DL transmission(s) may be not allowed.

In some example embodiments, the third TX/RX mode may be a mode 3-1 in which both a UL transmission and a DL transmission for synchronization, beam management, radio link recovery, or random access are allowed. For example, a DL transmission of SSB and/or SIB1 and other system information may be allowed. A UL transmission of the PRACH may be allowed. A DL transmission of a random access response (RAR) may be allowed.

In some example embodiments, the third TX/RX mode may be a mode 3-2 in which all UL transmissions and DL transmissions are allowed.

As shown in FIG. 5A, in the mode 3-1, a DL transmission of SSB and SIB1 and a UL transmission of the RO may be allowed. In contrast, other UL transmission and other DL transmission may be not allowed. Alternatively, a DL transmission of SSB and SIB1, a UL transmission of the RO, and a DL transmission of the RAR may be allowed (now shown).

As shown in FIG. 5B, in the mode 3-2, all UL transmissions and DL transmissions may be allowed.

It is to be noted that, the “actual active time” shown in FIGS. 3A-3D, 4A-4C and 5A-5B may be a portion of an on-duration during which at least one channel or signal is transmitted or received.

As mentioned above, the terminal device 120 selects 210 the target TX/RX mode from the plurality of TX/RX modes based on a predefined condition associated with the target TX/RX mode. In other words, the terminal device 120 selects 210 the target TX/RX mode of the serving cell depending on which predefined condition is met.

In some example embodiments, the predefined condition may be a first predefined condition associated with the first TX/RX mode. The first predefined condition may comprise a condition 1-1 that synchronization maintenance, beam management, RRM measurement or radio link monitoring is needed in a next on-duration in the DTX/DRX mode.

Alternatively, the condition 1-1 may be defined as determining that a time duration from last detection or measurement of a SSB or a CSI-RS to a next transmission occasion of a SSB or a CSI-RS, a next transmission occasion of the wake-up information, or a starting time of the next on-duration is equal to or larger than a threshold.

In some example embodiments, the next transmission occasion of the SSB may be the first SSB transmission occasion in an on-duration of a DTX/DRX cycle. The time duration from the last detection or measurement to the next transmission occasion of the wake-up information may be defined as a time duration from the last detection or measurement to a starting time or a ending time of the next C-WUS transmission occasion.

If the condition 1-1 is met, the terminal device 120 may select 210 the mode 1-1 as the target TX/RX mode.

The first predefined condition may comprise a condition 1-2 that a check or update of system information is needed in the next on-duration.

Alternatively, the condition 1-2 may be defined as determining that a time duration from the system information was last received to a next transmission occasion of a SSB or SIB1, a next transmission occasion of the wake-up information or a starting time of the next on-duration is equal to or larger than a threshold.

If the condition 1-2 is met, the terminal device 120 may select 210 the mode 1-2 as the target TX/RX mode.

It is to be noted that value of the abovementioned “threshold” may be configured by the network device 110 and/or determined based on capabilities of the terminal device 120. As an example, the value of the threshold may be equal to the value defined in 3GPP TS 38.133. As another example, the value of the threshold may be an integer of millisecond, e.g., 200 ms. As another example, the value of the threshold may be an integer multiple of the periodicity of SSB/CSI-RS resource. In addition, the value may be also associated with whether a DRX is configured to the terminal device 120.

The first predefined condition may comprise a condition 1-3 that a DL data transmission is needed in the next on-duration. Alternatively, the condition 1-3 may be defined as determining that a delay budget of DL traffic is to expire if no DL transmission is performed in the next on-duration. If the condition 1-3 is met, the terminal device 120 may select the mode 1-3 as the target TX/RX mode.

The first predefined condition may comprise a condition 1-4 that the condition 1-3 and at least one of the condition 1-1 and condition 1-2 are met. If the condition 1-3 is met, the terminal device 120 may select the mode 1-4 as the target TX/RX mode.

In some example embodiments, the predefined condition may be a second predefined condition associated with the second TX/RX mode. The second predefined condition may comprise a condition 2-1 that a random access procedure is needed in the next on-duration. For example, the terminal device 120 may determine that the condition 2-1 is met by determining that a random access procedure is needed due to uplink synchronization, radio link recovery or arrival of UL data.

If the condition 2-1 is met, the terminal device 120 may select 210 the mode 2-1 as the target TX/RX mode.

In some example embodiments, the second predefined condition may comprise a condition 2-2 that a PUCCH or a PUSCH is needed in the next on-duration. For example, the terminal device 120 may determine that the condition 2-2 is met by determining that UL data has arrived and the PUSCH is needed to be transmitted in the next on-duration.

If the condition 2-2 is met, the terminal device 120 may select 210 the mode 2-2 as the target TX/RX mode.

In some example embodiments, the second predefined condition may comprise a condition 2-3 that the condition 2-1 and the condition 2-2 are met. If the condition 2-3 is met, the terminal device 120 may select 210 the mode 2-3 as the target TX/RX mode.

In some example embodiments, the predefined condition may be a third predefined condition associated with the third TX/RX mode. The third predefined condition may comprise a condition 3-1 that the condition 1-1 and the condition 2-1 are met. If the condition 3-1 is met, the terminal device 120 may select 210 the mode 3-1 as the target TX/RX mode.

In some example embodiments, the third predefined condition may comprise a condition 3-2 that the condition 1-4 and the condition 2-3 are met. If the condition 3-2 is met, the terminal device 120 may select 210 the mode 3-2 as the target TX/RX mode.

In this way, the target TX/RX mode may be selected and requested based on requirement of the terminal device 120. Then the network device 110 may avoid unnecessary transmission(s) or reception(s) which is not needed by the terminal device 120, thereby improving the energy saving effect.

Referring back to FIG. 2, the terminal device 120 transmits 220 wake-up information 222 (also referred to as cell wake-up information or cell wake-up signal (C-WUS)) to the network device 110. The wake-up information 222 requests the serving cell in a DTX/DRX mode to wake up into the target TX/RX mode.

In some example embodiments, the wake-up information 222 may indicate a specific TX/RX mode for a specific serving cell or a specific cell group. In addition, the wake-up information 222 may indicate a number of TX/RX modes and each TX/RX mode is associated with a specific serving cell or a specific cell group. In this way, the wake-up information may be a wake-up signal for multi-cells and multi-modes.

In some example embodiments, when the terminal device 120 is configured with a plurality of serving cells, the terminal device 120 may select one or more serving cells to be woken up based on an order of the plurality of serving cells. Then the terminal device 120 may select 210 a respective target TX/RX mode for each of the one or more selected serving cells.

In some example embodiments, the wake-up information 222 may be uplink control information (UCI). The target TX/RX mode for a serving cell or a cell group may be indicated by a value of a UCI field. In this case, in response to determining that a condition is met, the terminal device 120 may send a cell wake-up signal with the value of the UCI field associated with condition to request a target serving cell or cell group to wake up into the target TX/RX mode associated with the condition.

In some example embodiments, the terminal device 120 may transmit 220 the wake-up information 222 in the serving cell to be woken up or another serving cell. The other serving cell may be a Pcell or a PScell. For example, if the cell 131 is the target serving cell to be woken up, the terminal device 120 may transmit 220 the wake-up information in the cell 131 or the cell 132.

In some example embodiments, the terminal device 120 may transmit 220 the wake-up information 222 via at least one of a media access control (MAC) control element (CE), a physical uplink control channel (PUCCH), or a physical random access channel (PRACH).

In some example embodiments, the terminal device 120 may transmit 220 the wake-up information 222 via a MAC CE in response to determining that a UL-shared channel (SCH) resource is available in the serving cell to be woken up or another serving cell.

Alternatively, in response to determining that no UL-shared channel (SCH) resource is available in the serving cell to be woken up or another serving cell, the terminal device 120 may transmit 220 the wake-up information 222 in a predefined transmission occasion.

In some example embodiments, the predefined transmission occasion may be a PUCCH transmission occasion. Alternatively, the predefined transmission occasion may be a PRACH transmission occasion. In some example embodiments, the predefined transmission occasion may be configured in the serving cell to be woken up, or in a Pcell or a PSCell, or in a cell not in the DTX/DRX mode.

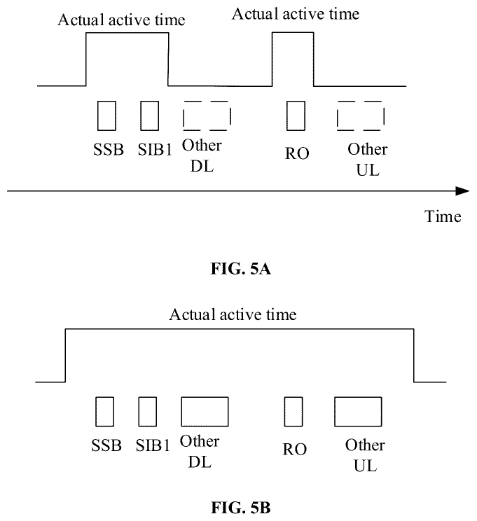

Reference is now made to FIG. 6A-6B, which illustrates examples of transmission of the wake-up information in a PUCCH resource in accordance with some example embodiments of the present disclosure.

In some example embodiments, the terminal device 120 may transmit the wake-up information 222 by transmitting a sequence using a PUCCH resource of a set of PUCCH resources configured to the terminal device 120. Each of the set of PUCCH resources may be configured with at least one sequence, e.g., a ZC sequence with a particular cyclic shift, or a computer generated sequence. Each of the at least one sequence may be associated with a TX/RX mode of a cell.

As shown in FIG. 6A, four PUCCH resources may be assigned to the terminal device 120 and each PUCCH resource is associated with a single sequence. In this case, the terminal device 120 may transmit a sequence in the PUCCH resource 611 to indicate a mode 1 of cell 1. Alternatively, the terminal device 120 may transmit a sequence in the PUCCH resource 612 to indicate a mode 2 of cell 1. Alternatively, the terminal device 120 may transmit a sequence in the PUCCH resource 613 to indicate mode 1 of cell 2. Alternatively, the terminal device 120 may transmit a sequence in the PUCCH resource 614 to indicate a mode 2 of cell 2.

As shown in FIG. 6B, as another example, two PUCCH resources are assigned to the terminal device 120 and each PUCCH resource is associated with two sequences. In this case, the terminal device 120 may transmit a first sequence in the PUCCH resource 621 to indicate a mode 1 of cell 1. Alternatively, the terminal device 120 may transmit a second sequence in the PUCCH resource 621 to indicate a mode 2 of cell 1. Alternatively, the terminal device 120 may transmit a first sequence in the PUCCH resource 622 to indicate a mode 1 of cell 2. Alternatively, the terminal device 120 may transmit a second sequence in the PUCCH resource 622 to indicate a mode 2 of cell 2.

In some example embodiments, the PUCCH may be of a PUCCH format 0 and may be a group common PUCCH. In other words, another terminal device may send same wake-up information 222 by transmitting a same sequence in a same PUCCH resource associated with the wake-up information 222. In this way, the wake-up information 222 may be transmitted in an overlap manner.

In some example embodiments, the terminal device 120 may transmit 220 the wake-up information 222 via the PRACH by transmitting a PRACH preamble in a set of PRACH preambles configured to the terminal device 120. Each of the set of PRACH preambles may be associated with a TX/RX mode of a cell.

In addition, the terminal device 120 may transmit the PRACH preamble in a set of PRACH occasions configured for transmitting the wake-up information 222. In other words, the terminal device 120 may only transmit the PRACH preamble associated with the wake-up information 222 in the specifically configured PRACH occasions.

In addition, the terminal device 120 may transmit the PRACH preamble in a radio resource control (RRC) idle mode of the terminal device 120.

Referring back to FIG. 2, on the other side of communication, the network device 110 receives 230 the wake-up information 222. In response to receiving the wake-up information 222, the network device 110 configures 240 the serving cell in one of the DTX/DRX mode and the plurality of TX/RX modes.

In some example embodiments, the network device 110 may configure the serving cell to be woken up by converting the serving cell from the DTX/DRX mode to the target TX/RX mode.

In some example embodiments, the network device 110 may transmit acknowledgement information for the wake-up information 222 to the terminal device 120. The network device 110 may transmit the acknowledgement information after the transmission occasion of the wake-up information 222 and before a starting time of the next on-duration.

As an example, the acknowledgement information may indicate that the target serving cell will wake up into the target TX/RX mode in the next on-duration. As another example, the acknowledgement information may indicate that the target serving cell will wake up into another TX/RX mode other than the target TX/RX mode in the next on-duration. In this case, the terminal device 120 may determine or assume the other TX/RX mode will be used in the next on-duration.

In some example embodiments, the acknowledgement information may be group common downlink control information (DCI). For example, the acknowledgement information may be a UE wake up signal, e.g., DCI format 2-6. The acknowledgement information may be indicated to a group of UEs comprising the terminal device 120.

Alternatively, the acknowledgement information may be a hybrid automatic repeat request (HARQ)-acknowledgement (ACK) associated with the wake-up information. When an ACK is indicated, the terminal device 120 may determine or assume that the transmitted wake up information 222 will be adopted by the network device 110 in the next on-duration.

In some example embodiments, the acknowledgement information may be transmitted in the serving cell. Alternatively or in addition, the acknowledgement information may be transmitted in a serving cell in which the wake-up information 222 is transmitted.

In some example embodiments, the terminal device 120 may monitor the acknowledgement information in a monitor window configured to the terminal device 120. The terminal device 120 may determine a duration of the monitor window for monitoring the acknowledgement information and determine a start point of the monitor window based on a start point or an end point of the transmission occasion of the wake-up information. For example, the terminal device 120 may be configured with the duration of the monitor window and an offset from a starting/ending time of the transmission occasion of the wake-up information 222.

In some example embodiments, the network device 110 may configure the serving cell to be woken up by keeping the serving cell in the DTX/DRX mode. In other words, the network device 110 may reject the request to wake up the target serving cell into the target TX/RX mode.

In some example embodiments, the network device 110 may transmit negative acknowledgement information for the wake-up information 222 to the terminal device 120. The negative acknowledgement information may be a NACK in the case of HARQ. When the NACK is indicated, the terminal device 120 may determine or assume that the request to wake up the target serving cell into the target TX/RX mode is rejected.

Alternatively, when no acknowledgement information is received in the monitor window, the terminal device 120 may determine or assume that the request to wake up the target serving cell into the target TX/RX mode is rejected.

Alternatively, when no acknowledgement information is received in the monitor window, the terminal device 120 may determine or assume the transmitted wake up information 222 will be adopted by the network device 110 in the next on-duration. In other words, even if the terminal device 120 does not receive the acknowledgement information, the terminal device 120 may still determine or assume that the target serving cell will wake up in the next on-duration. In this way, if the terminal device 120 does not receive the acknowledgement information that was actually sent by the network device 110, for example, due to misdirection of the acknowledgement information, possible DL/UL transmission(s) may not be missed in the next on-duration.

In some example embodiments, the network device 110 may configure the serving cell to be woken up by converting the serving cell from the DTX/DRX mode to a TX/RX mode of a set of TX/RX modes supported by the network device 110 and the terminal device 120. In other words, the network device 110 may determine a different TX/RX mode based on the wake-up information 222 and configure the serving cell in the determined TX/RX mode.

With the acknowledgement information and/or negative acknowledgement information, the terminal device 120 and the network device 110 may obtain a common understanding of the behavior in the next on-duration and may avoid problems caused by misdetection of the wake-up information or overwriting by the network device 110.

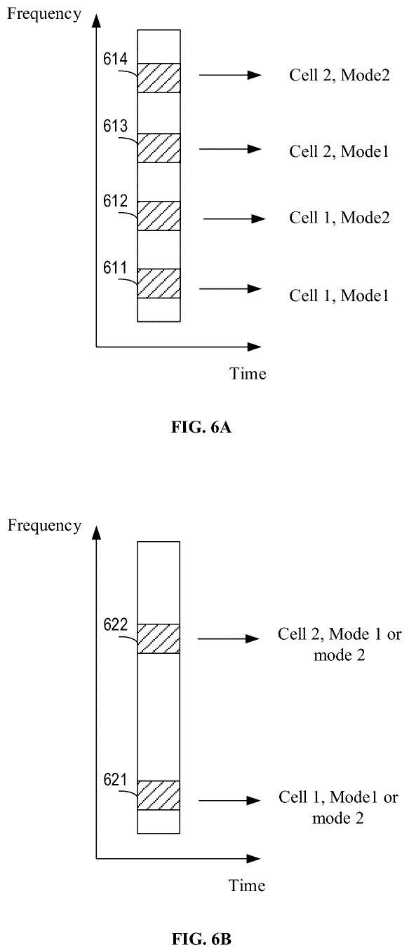

FIGS. 7A-7C illustrate examples of transmission and detection of the wake-up information in accordance with some embodiments of the present disclosure.

As shown in FIG. 7A, if the wake-up information 222 is detected by the network device 110, the network device 110 may transmit acknowledgement information to the terminal device 120 before the next on-duration. The network device 110 may configure the target serving cell in the target TX/RX mode and thus transmission(s) and/or reception(s) associated with the target TX/RX mode may be allowed in the next on-duration.

In contrast, if the wake-up information 222 is not detected by the network device 110, the network device 110 may not transmit acknowledgement information to the terminal device 120 before the next on-duration. The network device 110 may keep the target serving cell in the DTX/DRX mode and thus the target serving cell may not wake up in the next on-duration.

As shown in FIG. 7B, if the CC2 is the target serving cell to be woken up, the wake-up information 222 may be transmitted in another serving cell CC1 via the MAC CE. If the wake-up information 222 is detected by the network device 110, the network device 110 may transmit acknowledgement information in the target serving cell CC2 to the terminal device 120 before the next on-duration. The network device 110 may configure the target serving cell CC2 in the target TX/RX mode and thus transmission(s) and/or reception(s) associated with the target TX/RX mode may be allowed in the next on-duration.

In contrast, if the wake-up information 222 is not detected by the network device 110, the network device 110 may not transmit acknowledgement information to the terminal device 120 before the next on-duration. The network device 110 may keep the target serving cell CC2 in the DTX/DRX mode and thus the target serving cell CC2 may not wake up in the next on-duration.

As shown in FIG. 7C, if the CC2 is the target serving cell to be woken up, the wake-up information 222 may be transmitted in another serving cell CC1 via the MAC CE. If the wake-up information 222 is detected by the network device 110, the network device 110 may transmit acknowledgement information in the other serving cell CC1 to the terminal device 120 before the next on-duration. The network device 110 may configure the target serving cell CC2 in the target TX/RX mode and thus transmission(s) and/or reception(s) associated with the target TX/RX mode may be allowed in the next on-duration.

In contrast, if the wake-up information 222 is not detected by the network device 110, the network device 110 may not transmit acknowledgement information to the terminal device 120 before the next on-duration. The network device 110 may keep the target serving cell CC2 in the DTX/DRX mode and thus the target serving cell CC2 may not wake up in the next on-duration.

According to the embodiments described with reference to FIG. 1 to FIG. 7, the terminal device 120 may transmit the wake-up information to the network device 110 to request a serving cell in the DTX/DRX mode to wake up into a target TX/RX mode of a plurality of TX/RX modes. In response to receiving the wake-up information, the network device 110 may configure the serving cell in one of the DTX/DRX mode and the plurality of TX/RX modes.

In this way, with the wake-up information, a target serving cell may be requested to wake up into a target TX/RX mode in which target transmission(s) or reception(s) is allowed. In other words, a joint design of the cell wake-up and the on-demand common signal may be achieved.

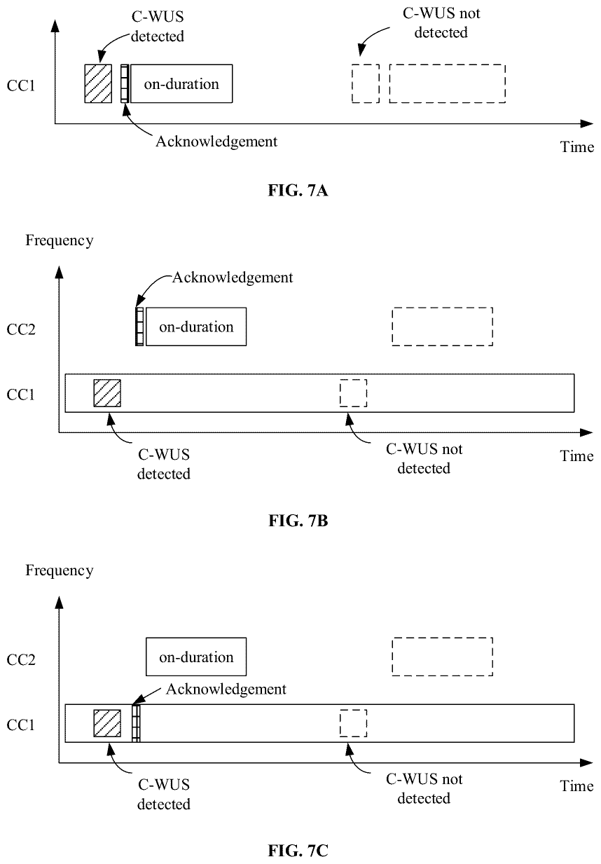

FIG. 8 illustrates a flowchart of an example method 800 implemented at a terminal device in accordance with some embodiments of the present disclosure. For the purpose of discussion, the method 800 will be described from the perspective of the terminal device 120 with reference to FIG. 1.

At block 810, the terminal device 120 selects a target transmission and reception (TX/RX) mode from a plurality of TX/RX modes of a serving cell of a network device 110 based on a redefined condition associated with the target TX/RX mode.

In some example embodiments, the plurality of TX/RX modes comprise at least one of the following: a first TX/RX mode in which a downlink (DL) transmission is allowed, a second TX/RX mode in which an uplink (UL) transmission is allowed, a third TX/RX mode in which both a DL transmission and a UL transmission are allowed, or a fourth TX/RX mode in which no transmission is allowed.

In some example embodiments, the first TX/RX mode is one of the following: a mode in which a DL transmission for synchronization, beam management, radio resource management (RRM) measurement, or radio link monitoring is allowed, a mode in which a DL transmission for system information is allowed, a mode in which a DL transmission for DL data is allowed, or a mode in which all DL transmissions are allowed.

In some example embodiments, the second TX/RX mode is one of the following: a mode in which a UL transmission for a random access procedure is allowed, a mode in which a UL transmission for uplink control information or UL data is allowed, or a mode in which all UL transmissions are allowed.

In some example embodiments, the third TX/RX mode is one of the following: a mode in which both a UL transmission and a DL transmission for synchronization, beam management, radio link recovery, or random access are allowed, or a mode in which all UL transmissions and DL transmissions are allowed.

In some example embodiments, the predefined condition comprises one of the following: a first predefined condition associated with the first TX/RX mode, a second predefined condition associated with the second TX/RX mode, a third predefined condition associated with the third TX/RX mode, or a fourth predefined condition associated with the fourth TX/RX mode.

At block 820, the terminal device 120 transmits, to the network device 110, wake-up information requesting the serving cell in a discontinuous transmission or reception (DTX/DRX) mode to wake up into the target TX/RX mode.

In some example embodiments, transmitting the wake-up information comprises transmitting the wake-up information in the serving cell or another serving cell via at least one of the following: a media access control (MAC) control element (CE), a physical uplink control channel (PUCCH), or a physical random access channel (PRACH).

In some example embodiments, transmitting the wake-up information via the PUCCH comprises: transmitting a sequence using a PUCCH resource of a set of PUCCH resources, each of the set of PUCCH resources being configured with at least one sequence, each of the at least one sequence being associated with a TX/RX mode of a cell.

In some example embodiments, the terminal device 120 further receives from the network device 110, acknowledgement information for the wake-up information.

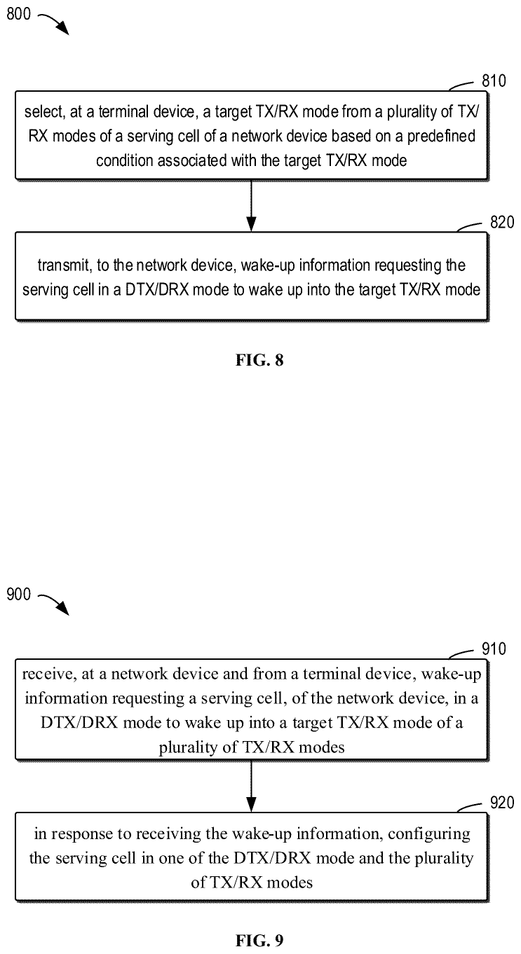

FIG. 9 illustrates a flowchart of an example method 900 implemented at a network device in accordance with some embodiments of the present disclosure. For the purpose of discussion, the method 900 will be described from the perspective of the network device 110 with reference to FIG. 1.

At block 910, the network device 110 receives, from a terminal device 120, wake-up information requesting a serving cell, of the network device, in a discontinuous transmission or reception (DTX/DRX) mode to wake up into a target transmission and reception (TX/RX) mode of a plurality of TX/RX modes.

In some example embodiments, the plurality of TX/RX modes comprise at least one of the following: a first TX/RX mode in which a downlink (DL) transmission is allowed, a second TX/RX mode in which an uplink (UL) transmission is allowed, a third TX/RX mode in which both a DL transmission and a UL transmission are allowed, or a fourth TX/RX mode in which no transmission is allowed.

In some example embodiments, the first TX/RX mode is one of the following: a mode in which a DL transmission for synchronization, beam management, radio resource management (RRM) measurement, or radio link monitoring is allowed, a mode in which a DL transmission for system information is allowed, a mode in which a DL transmission for DL data is allowed, or a mode in which all DL transmissions are allowed.

In some example embodiments, the second TX/RX mode is one of the following: a mode in which a UL transmission for a random access procedure is allowed, a mode in which a UL transmission for uplink control information or UL data is allowed, or a mode in which all UL transmissions are allowed.

In some example embodiments, the third TX/RX mode is one of the following: a mode in which both a UL transmission and a DL transmission for synchronization, beam management, radio link recovery, or random access are allowed, or a mode in which all UL transmissions and DL transmissions are allowed.

At block 920, in response to receiving the wake-up information, the network device 110 configures the serving cell in one of the DTX/DRX mode and the plurality of TX/RX modes.

In some example embodiments, receiving the wake-up information comprises receiving the wake-up information in the serving cell or another serving cell via at least one of the following: a media access control (MAC) control element (CE), a physical uplink control channel (PUCCH), or a physical random access channel (PRACH).

In some example embodiments, receiving the wake-up information via the PUCCH comprises: receiving a sequence in a PUCCH resource of a set of PUCCH resources, each of the set of PUCCH resources being configured with at least one sequence, each of the at least one sequence being associated with a TX/RX mode of a cell.

In some example embodiments, the network device 110 further transmits, to the terminal device 120, acknowledgement information for the wake-up information.

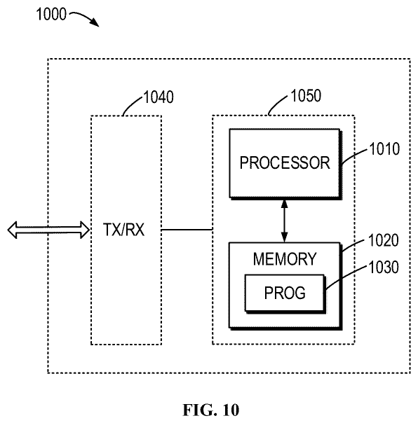

FIG. 10 illustrates a simplified block diagram of a device 1000 that is suitable for implementing embodiments of the present disclosure. The device 1000 can be considered as a further example implementation of the terminal device 120 and/or the network device 110 as shown in FIG. 1. Accordingly, the device 1000 can be implemented at or as at least a part of the terminal device 120 or the network device 110.

As shown, the device 1000 includes a processor 1010, a memory 1020 coupled to the processor 1010, a suitable transmitter (TX) and receiver (RX) 1040 coupled to the processor 1010, and a communication interface coupled to the TX/RX 1040. The memory 1010 stores at least a part of a program 1030. The TX/RX 1040 is for bidirectional communications. The TX/RX 1040 has at least one antenna to facilitate communication, though in practice an Access Node mentioned in this disclosure may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 1030 is assumed to include program instructions that, when executed by the associated processor 1010, enable the device 1000 to operate in accordance with the embodiments of the present disclosure, as discussed herein with reference to FIGS. 1-9. The embodiments herein may be implemented by computer software executable by the processor 1010 of the device 1000, or by hardware, or by a combination of software and hardware. The processor 1010 may be configured to implement various embodiments of the present disclosure. Furthermore, a combination of the processor 1010 and memory 1020 may form processing means 1050 adapted to implement various embodiments of the present disclosure.

The memory 1020 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 1020 is shown in the device 1000, there may be several physically distinct memory modules in the device 1000. The processor 1010 may be of any type suitable to the local technical network, and may include one or more of general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

In summary, embodiments of the present disclosure may provide the following solutions.

The present disclosure provides a method of communication, comprises: selecting, at a terminal device, a target transmission and reception (TX/RX) mode from a plurality of TX/RX modes of a serving cell of a network device based on a predefined condition associated with the target TX/RX mode; and transmitting, to the network device, wake-up information requesting the serving cell in a discontinuous transmission or reception (DTX/DRX) mode to wake up into the target TX/RX mode.

In one embodiment, the plurality of TX/RX modes comprise at least one of the following: a first TX/RX mode in which a downlink (DL) transmission is allowed, a second TX/RX mode in which an uplink (UL) transmission is allowed, a third TX/RX mode in which both a DL transmission and a UL transmission are allowed, or a fourth TX/RX mode in which no transmission is allowed.

In one embodiment, the first TX/RX mode is one of the following: a mode in which a DL transmission for synchronization, beam management, radio resource management (RRM) measurement, or radio link monitoring is allowed, a mode in which a DL transmission for system information is allowed, a mode in which a DL transmission for DL data is allowed, or a mode in which all DL transmissions are allowed.

In one embodiment, the second TX/RX mode is one of the following: a mode in which a UL transmission for a random access procedure is allowed, a mode in which a UL transmission for uplink control information or UL data is allowed, or a mode in which all UL transmissions are allowed.

In one embodiment, the third TX/RX mode is one of the following: a mode in which both a UL transmission and a DL transmission for synchronization, beam management, radio link recovery, or random access are allowed, or a mode in which all UL transmissions and DL transmissions are allowed.

In one embodiment, the predefined condition comprises one of the following: a first predefined condition associated with the first TX/RX mode, a second predefined condition associated with the second TX/RX mode, a third predefined condition associated with the third TX/RX mode, or a fourth predefined condition associated with the fourth TX/RX mode.

In one embodiment, the first predefined condition comprises one of the following: a first condition that synchronization maintenance, beam management, RRM measurement or radio link monitoring is needed in a next on-duration in the DTX/DRX mode, a second condition that a check or update of system information is needed in the next on-duration, a third condition that a DL data transmission is needed in the next on-duration, or a fourth condition that the third condition and at least one of the first condition and second condition are met.

In one embodiment, the first predefined condition comprises at least one of the following: determining that a time duration from last detection or measurement of a synchronization signal/physical broadcast channel block (SSB) or a channel state information-reference signal (CSI-RS) to a next transmission occasion of a SSB or a CSI-RS, a next transmission occasion of the wake-up information, or a starting time of the next on-duration is equal to or larger than a threshold, determining that a time duration from the system information was last received to a next transmission occasion of a SSB or system information block 1 (SIB1), a next transmission occasion of the wake-up information or a starting time of the next on-duration is equal to or larger than a threshold, and determining that a delay budget of DL traffic is to expire if no DL transmission is performed in the next on-duration.

In one embodiment, the second predefined condition comprises one of the following: a fifth condition that a random access procedure is needed in a next on-duration, a sixth condition that a physical uplink control channel (PUCCH) or a physical uplink shared channel (PUSCH) is needed in the next on-duration, or a seventh condition that the fifth condition and the sixth condition are met.

In one embodiment, the fifth condition comprises determining that a random access procedure is needed due to uplink synchronization, radio link recovery or arrival of UL data, and the sixth condition comprises determining that UL data has arrived and the PUSCH is needed to be transmitted.

In one embodiment, the third predefined condition comprises one of the following: an eighth condition that the first condition and the fifth condition are met, or a ninth condition that the fourth condition and the seventh condition are met.

In one embodiment, transmitting the wake-up information comprises transmitting the wake-up information in the serving cell or another serving cell via at least one of the following: a media access control (MAC) control element (CE), a physical uplink control channel (PUCCH), or a physical random access channel (PRACH).

In one embodiment, transmitting the wake-up information via the PUCCH comprises: transmitting a sequence using a PUCCH resource of a set of PUCCH resources, each of the set of PUCCH resources being configured with at least one sequence, each of the at least one sequence being associated with a TX/RX mode of a cell.

In one embodiment, the PUCCH is of a PUCCH format 0 and is a group common PUCCH.

In one embodiment, transmitting the wake-up information via the PRACH comprises at least one of the following: transmitting a PRACH preamble in a set of PRACH preambles, each of the set of PRACH preambles being associated with a TX/RX mode of a cell, or transmitting a PRACH preamble in a set of PRACH occasions configured for transmitting the wake-up information.

In one embodiment, the PRACH preamble is transmitted in a radio resource control (RRC) idle mode of the terminal device.

In one embodiment, transmitting the wake-up information comprises: in response to determining that a UL-shared channel (SCH) resource is available in the serving cell or another serving cell, transmitting the wake-up information via a MAC CE, and in response to determining that no UL-shared channel (SCH) resource is available in the serving cell or another serving cell, transmitting the wake-up information in a predefined transmission occasion for the wake-up information.

In one embodiment, the predefined transmission occasion is at least one of the following: a PUCCH transmission occasion, a PRACH transmission occasion, configured in the serving cell to be woken up, configured in a primary cell (Pcell) or a primary secondary cell (PSCell), or configured in a cell not in a DTX/DRX mode.

In one embodiment, the method further comprises: receiving, from the network device, acknowledgement information for the wake-up information.

In one embodiment, the acknowledgement information is transmitted in the serving cell or in a serving cell in which the wake-up information is transmitted, and wherein the acknowledgement information is group common downlink control information (DCI), or a hybrid automatic repeat request (HARQ)-acknowledgement (ACK).

In one embodiment, the method further comprises: determining a duration of a monitor window for monitoring the acknowledgement information; determining a start point of the monitor window based on a start point or an end point of a transmission occasion of the wake-up information; and monitoring the acknowledgement information in the monitor window.

In one embodiment, the method further comprises: in response to receiving negative acknowledgement information for the wake-up information or failing to receive acknowledgement information for the wake-up information, determining that the serving cell is not to wake up into the target TX/RX mode.

In one embodiment, the wake-up information requests a group of serving cells comprising the serving cell to wake up into the target TX/RX mode.

The present disclosure provides a method of communication, comprises: receiving, at a network device and from a terminal device, wake-up information requesting a serving cell, of the network device, in a discontinuous transmission or reception (DTX/DRX) mode to wake up into a target transmission and reception (TX/RX) mode of a plurality of TX/RX modes; and in response to receiving the wake-up information, configuring the serving cell in one of the DTX/DRX mode and the plurality of TX/RX modes.

In one embodiment, configuring the serving cell comprises converting the serving cell from the DTX/DRX mode to the target TX/RX mode.

In one embodiment, the plurality of TX/RX modes comprise at least one of the following: a first TX/RX mode in which a downlink (DL) transmission is allowed, a second TX/RX mode in which an uplink (UL) transmission is allowed, a third TX/RX mode in which both a DL transmission and a UL transmission are allowed, or a fourth TX/RX mode in which no transmission is allowed.

In one embodiment, the first TX/RX mode is one of the following: a mode in which a DL transmission for synchronization, beam management, radio resource management (RRM) measurement, or radio link monitoring is allowed, a mode in which a DL transmission for system information is allowed, a mode in which a DL transmission for DL data is allowed, or a mode in which all DL transmissions are allowed.

In one embodiment, the second TX/RX mode is one of the following: a mode in which a UL transmission for a random access procedure is allowed, a mode in which a UL transmission for uplink control information or UL data is allowed, or a mode in which all UL transmissions are allowed.

In one embodiment, the third TX/RX mode is one of the following: a mode in which both a UL transmission and a DL transmission for synchronization, beam management, radio link recovery, or random access are allowed, or a mode in which all UL transmissions and DL transmissions are allowed.

In one embodiment, the wake-up information is received in the serving cell or another serving cell via at least one of the following: a media access control (MAC) control element (CE), a physical uplink control channel (PUCCH), or a physical random access channel (PRACH).

In one embodiment, receiving the wake-up information via the PUCCH comprises: receiving a sequence in a PUCCH resource of a set of PUCCH resources, each of the set of PUCCH resources being configured with at least one sequence, each of the at least one sequence being associated with a TX/RX mode of a cell.

In one embodiment, the PUCCH is of a PUCCH format 0 and is a group common PUCCH.

In one embodiment, receiving the wake-up information via the PRACH comprises at least one of the following: receiving a PRACH preamble in a set of PRACH preambles, each of the set of PRACH preambles being associated with a TX/RX mode of a cell, or receiving a PRACH preamble in a set of PRACH occasions configured for the terminal device to transmit the wake-up information.

In one embodiment, the PRACH preamble is received from the terminal device in a radio resource control (RRC) idle mode.

In one embodiment, receiving the wake-up information comprises: receiving the wake-up information via a MAC CE when a UL-shared channel (SCH) resource is available, and receiving the wake-up information in a predefined transmission occasion for the wake-up information when no UL-shared channel (SCH) resource is available.

In one embodiment, the predefined transmission occasion is at least one of the following: a PUCCH transmission occasion, a PRACH transmission occasion, configured in the serving cell to be woken up, configured in a primary cell (Pcell) or a primary secondary cell (PSCell), or configured in a cell not in a DTX/DRX mode.

In one embodiment, the method further comprises: transmitting, to the terminal device, acknowledgement information for the wake-up information.

In one embodiment, the acknowledgement information is transmitted in the serving cell or in a serving cell in which the wake-up information is transmitted, and wherein the acknowledgement information is group common downlink control information (DCI), or a hybrid automatic repeat request (HARQ)-acknowledgement (ACK).

In one embodiment, the method further comprises: transmitting, to the terminal device, negative acknowledgement information for the wake-up information to indicate that the serving cell is not to wake up into the target TX/RX mode.

In one embodiment, the wake-up information requests a group of serving cells comprising the serving cell to wake up into the target TX/RX mode and the method comprises updating the group of serving cells to wake up into the target TX/RX mode.

The present disclosure provides a terminal device, comprising: a processor; and a memory storing computer program codes; the memory and the computer program codes configured to, with the processor, cause the terminal device to perform the method implemented at the terminal device discussed above.

The present disclosure provides a network device, comprising: a processor; and a memory storing computer program codes; the memory and the computer program codes configured to, with the processor, cause the network device to perform the method implemented at the network device discussed above.

The present disclosure provides a computer readable medium having instructions stored thereon, the instructions, when executed by a processor of an apparatus, causing the apparatus to perform the method implemented at a terminal device or a network device discussed above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 8-9. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1.-20. (canceled)

21. A method of communication performed by a terminal device, comprising:
determining a target transmission and reception (TX/RX) mode from a plurality of TX/RX modes of a serving cell of a network device; and
transmitting, to the network device via a physical random access channel (PRACH), wake-up information indicating the target TX/RX mode;
wherein the plurality of TX/RX modes comprise at least one of:
a first TX/RX mode in which a System Information Block 1 (SIB1) would be transmitted; and
a second TX/RX mode in which the SIB1 would not be transmitted.

22. The method of claim 21, wherein the plurality of TX/RX modes comprise a third TX/RX mode in which a downlink (DL) transmission is allowed, the third TX/RX mode is one of the following:
a mode in which a DL transmission for synchronization, beam management, radio resource management (RRM) measurement, or radio link monitoring is allowed,
a mode in which a DL transmission for system information is allowed,
a mode in which a DL transmission for DL data is allowed, or
a mode in which all DL transmissions are allowed.

23. The method of claim 21, wherein the plurality of TX/RX modes comprise a fourth TX/RX mode in which an uplink (UL) transmission is allowed, the fourth TX/RX mode is one of the following:
a mode in which a UL transmission for a random access procedure is allowed,
a mode in which a UL transmission for uplink control information or UL data is allowed, or
a mode in which all UL transmissions are allowed.

24. The method of claim 21, wherein the plurality of TX/RX modes comprise a fifth TX/RX mode in which both a DL transmission and a UL transmission are allowed, the fifth TX/RX mode is one of the following:
a mode in which both a UL transmission and a DL transmission for synchronization, beam management, radio link recovery, or random access are allowed, or
a mode in which all UL transmissions and DL transmissions are allowed.

25. The method of claim 21, wherein the target TX/RX mode is determined based on a predefined condition, the predefined condition comprises one of the following:
a first predefined condition associated with the first TX/RX mode,
a second predefined condition associated with the second TX/RX mode,
a third predefined condition associated with the third TX/RX mode, or
a fourth predefined condition associated with the fourth TX/RX mode.

26. The method of claim 21, further comprising:
transmitting a sequence using a PUCCH resource of a set of PUCCH resources, each of the set of PUCCH resources being configured with at least one sequence, each of the at least one sequence being associated with a TX/RX mode of a cell.

27. The method of claim 21, further comprising:
receiving, from the network device, acknowledgement information for the wake-up information.

28. A method of communication performed by a network device, comprising:
receiving, from a terminal device via a physical random access channel (PRACH), wake-up information indicating a target transmission and reception (TX/RX) mode of a plurality of TX/RX modes;
wherein the plurality of TX/RX modes comprise at least one of:
a first TX/RX mode in which a System Information Block 1 (SIB1) would be transmitted; and
a second TX/RX mode in which the SIB1 would not be transmitted.

29. The method of claim 28, wherein the plurality of TX/RX modes comprise a third TX/RX mode in which a downlink (DL) transmission is allowed, the third TX/RX mode is one of the following:
a mode in which a DL transmission for synchronization, beam management, radio resource management (RRM) measurement, or radio link monitoring is allowed,
a mode in which a DL transmission for system information is allowed,
a mode in which a DL transmission for DL data is allowed, or
a mode in which all DL transmissions are allowed.

30. The method of claim 28, wherein the plurality of TX/RX modes comprise a fourth TX/RX mode in which an uplink (UL) transmission is allowed, the fourth TX/RX mode is one of the following:
a mode in which a UL transmission for a random access procedure is allowed,
a mode in which a UL transmission for uplink control information or UL data is allowed, or
a mode in which all UL transmissions are allowed.

31. The method of claim 28, wherein the plurality of TX/RX modes comprise a fifth TX/RX mode in which both a DL transmission and a UL transmission are allowed, the fifth TX/RX mode is one of the following:
a mode in which both a UL transmission and a DL transmission for synchronization, beam management, radio link recovery, or random access are allowed, or
a mode in which all UL transmissions and DL transmissions are allowed.

32. The method of claim 28, wherein further comprising:
receiving a sequence in a PUCCH resource of a set of PUCCH resources, each of the set of PUCCH resources being configured with at least one sequence, each of the at least one sequence being associated with a TX/RX mode of a cell.

33. The method of claim 28, further comprising:
transmitting, to the terminal device, acknowledgement information for the wake-up information.

34. A terminal device comprising:
a processor configured to cause the terminal device to:
determine a target transmission and reception (TX/RX) mode from a plurality of TX/RX modes of a serving cell of a network device; and
transmit, to the network device via a physical random access channel (PRACH), wake-up information indicating the target TX/RX mode;
wherein the plurality of TX/RX modes comprise at least one of:
a first TX/RX mode in which a System Information Block 1 (SIB1) would be transmitted; and
a second TX/RX mode in which the SIB1 would not be transmitted.
